(19) United States
(12) Patent Application Publication
(10) Pub. No.: US 2023/0302526 A1
(43) Pub. Date: Sep. 28, 2023

(54) Reinforcement Cage Rolling Machine

(71) Applicant: CHINA MCC5 GROUP CORP. LTD., Chendu (CN)

(72) Inventors: Jihong SHAN, Chendu (CN); Baiyuan WANG, Chendu (CN); Xiaofei SONG, Chendu (CN); Yue HE, Chendu (CN); Jianxun DENG, Chendu (CN)

(21) Appl. No.: 17/819,195

(22) Filed: Aug. 11, 2022

(30) Foreign Application Priority Data
Mar. 23, 2022 (CN) 202210288036.9

(51) Int. Cl. B21F 27/08; B21F 27/20

(52) U.S. Cl. CPC B21F 27/08; B21F 27/20

(57) ABSTRACT

A reinforcement cage rolling machine has a driving mechanism; an earth axis connected to a driving end of the driving mechanism; a stable feeding mechanism, connected to the earth axis; a main flange arranged on the earth axis; a secondary flange arranged on the earth axis; a spacing regulating mechanism arranged on the main flange and the secondary flange.

The spacing regulating mechanism arranged on the main flange and the secondary flange can regulate the spacing between the reinforcements, so as to improve the overall stability of the reinforcement cage meets the quality standard and avoid potential safety hazards.

### TECHNICAL FIELD

The present invention relates to the technical field of cage rolling machine, particularly to a reinforcement cage rolling machine.

### BACKGROUND

At present, the cage rolling machines of bridge piers and pile foundation frameworks in China are basically made by using cage rolling machinery. The making method is as follows: 1. welding the main reinforcement on the cement floor according to the designed length; 2. hoisting the semi-finished reinforcement cage framework onto the reinforcement cage framework machine by a truck crane after it is fixed; 3. programming the technical parameters of the reinforcement winding in the numerical control operating system by the professional technicians; 4. commissioning the machinery, start to wind the stiffener of the reinforcement cage after the machinery operates normally; 5. hoisting the formed reinforcement cage to the finished product stacking area by a truck crane for manual binding. Therefore, the following problems exist: the whole reinforcement cage is operated in this way, and the main reinforcement of the reinforcement cage is not centered and not on the same axis; there are quality and technical safety hazards in the overlapping of the reinforcement cages, the overall stability and the spacing standard of the reinforcement cage; At the same time, this process is labor-consuming, time-consuming, uneconomical, inefficient, and more wasteful of resources.

### SUMMARY

The invention is intended to solve at least one of the technical problems in the prior art.

To this end, the present invention provides a reinforcement cage rolling machine.

The present invention provides a reinforcement cage rolling machine, comprising:
a driving mechanism;
an earth axis, connected with a driving end of the driving mechanism;
a stable feeding mechanism, connecting the earth axis;
a main flange, arranged on the earth axis;
a secondary flange, arranged on the earth axis;
a spacing regulating mechanism, arranged on the main flange and the secondary flange.

The reinforcement cage rolling machine proposed by the present invention comprises a driving mechanism, an earth axis, a stable feeding mechanism, a main flange, a secondary flange and a spacing regulating mechanism. The driving mechanism is used to provide a driving force for the earth axis, thereby driving the earth axis to rotate. The earth axis can be stably placed on the ground through provision of several bearing frames. The stable feeding mechanism is used to ensure the automatic feeding process of reinforcement, so as to avoid the hidden dangers in feeding by workers. The spacing regulating mechanism arranged on the main flange and the secondary flange can regulate the spacing between the reinforcements, so as to ensure that the overall stability of the reinforcement cage meets the quality standard and avoid potential safety hazards. In addition, the reinforcement cage rolling machine proposed by the invention automatically realizes the construction process of feeding and processing the reinforcement cage, saves time and labor, reduces the construction cost and improves the economic benefit.

The reinforcement cage rolling machine according to the above technical solution of the present invention may also have the following additional technical features:

In the above technical solution, the spacing regulating mechanism comprises:
a mounting shaft, the main flange and the secondary flange forming a mounting hole, a torsion spring being arranged in the mounting hole, and the mounting shaft being sleeved with the torsion spring;
a spacing regulator, arranged on the mounting shaft;
a spacing regulating member, arranged on the spacing regulator;
a positioning bolt, arranged on the main flange and the secondary flange and located in contact with the side wall surface of the spacing regulator.

In this technical solution, the spacing regulating mechanism comprises a mounting shaft, a torsion spring, a spacing regulator, a spacing regulating member and a positioning bolt. The torsion spring can ensure the reset of the mounting shaft, thereby driving the spacing regulator and the spacing regulating member to reset. The specific spacing regulating process is to change the spacing between reinforcements by rotating the spacing regulator by a certain angle. In addition, the spacing regulator is of a slotted structure, and the spacing regulating member is arranged in the slot and can be integrally formed with the spacing regulator. One end of the spacing regulator is provided with a mounting hole for rotationally connecting with the mounting shaft. At least one end of the spacing regulating member is of a semicircular notch to provide a clamping space for the reinforcement. The positioning bolt is in contact with the side wall surface of the spacing regulator to limit the freedom of the spacing regulator.

The above technical solution further comprises:
a main feeding port, formed at one end of the spacing regulating member (1064) of the main flange. This technical solution further comprises a main feeding port. The main feeding port is used to clamp reinforcements and realize the position change of the main feeding port through the spacing regulator and the spacing regulating member, thereby changing the spacing between the reinforcement cages.

The above technical solution further comprises:
a secondary feeding port, formed at one end of the spacing regulating member of the secondary flange.

This technical solution further comprises a secondary feeding port. The secondary feeding port is formed in the same manner as that of the main feeding port, and both of them are formed by the semicircular north of the spacing regulating member.

In the above technical solution, the quantity of the main feeding ports is four; and/or the quantity of the secondary feeding ports is two.

In this technical solution, there are four main feeding ports, and correspondingly, there are two secondary feeding ports. Of course, the quantity of both is determined according to the actual working conditions.

The above technical solution further comprises:
a plugging piece, arranged on the secondary flange and connected with part of the main feeding port.

This technical solution further comprises a plugging piece. The plugging piece is used to plug part of the main feeding port, in order to prevent the reinforcement from passing through the main feeding port.

In the above technical solution, the driving mechanism comprises:
a motor;
a small sheave, arranged at the driving end of the motor;
a reducer, arranged at one side of the motor;
a big sheave, arranged on the reducer, and the small sheave being connected with the big sheave through a driving belt.

In this technical solution, the driving mechanism comprises a motor, a small sheave, a reducer and a big sheave. The motor drives the small sheave to rotate, thereby driving the big sheave to rotate through a driving belt, and further driving the reducer.

In the above technical solution, the earth axis is connected with the driving end of the reducer through a coupling.

In this technical solution, the earth axis is connected with the driving end of the reducer through a coupling. When the motor drives the reducer to rotate through a series of linkage, the reducer drives the earth axis to rotate through the coupling.

In the above technical solution, the stable feeding mechanism comprises:
a stable table, the table top of the stable table being an inclined structure;
a roller sprocket device, rotationally connected with the stable table at one end close to the earth axis, and a lift regulating element being arranged at one end away from the earth axis;
wherein, a sprocket is arranged on the earth axis, and a roller chain of the roller sprocket device is sleeved with the sprocket.

In this technical solution, the stable feeding mechanism comprises a stable table, a roller sprocket device and a lift regulating element. A mounting groove is provided in the middle of the stable table. The sprocket near the earth axis in the roller sprocket device is rotationally connected with the mounting groove, and the other end of the roller sprocket device is connected with the lift regulating element. In addition, the earth axis is also provided with a sprocket, and the roller chain of the roller sprocket device is connected to this sprocket to form a complete feeding mechanism. The height of one end of the roller sprocket device can be regulated by the lift regulating element.

In the above technical solution, the roller sprocket device is provided with several equidistant placement stations.

In this technical solution, the roller sprocket device is provided with several equidistant placement stations which are used to hold reinforcements, change the reinforcement placement spacing and realize the change of spacing between reinforcements.

The additional aspects and advantages of the present invention would become clear from the description below or would be understood through the practice of the present invention.

### BRIEF DESCRIPTION OF THE DRAWINGS

The aspects and advantages mentioned above and/or attached would be clear and easy to understand through the description of embodiments combining the following drawings, wherein:

FIG. 1 is a structural connection diagram of the reinforcement cage rolling machine of the present invention;

FIG. 2 is a front view of the stable feeding mechanism in the reinforcement cage rolling machine of the present invention;

FIG. 3 is a top view of the stable feeding mechanism in the reinforcement cage rolling machine of the present invention;

FIG. 4 is a connection diagram of the stable feeding mechanism in the reinforcement cage rolling machine of the present invention;

FIG. 5 is a structural diagram of the main flange in the reinforcement cage rolling machine of the present invention.

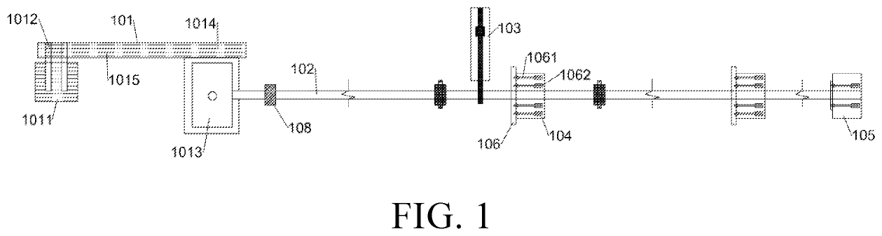

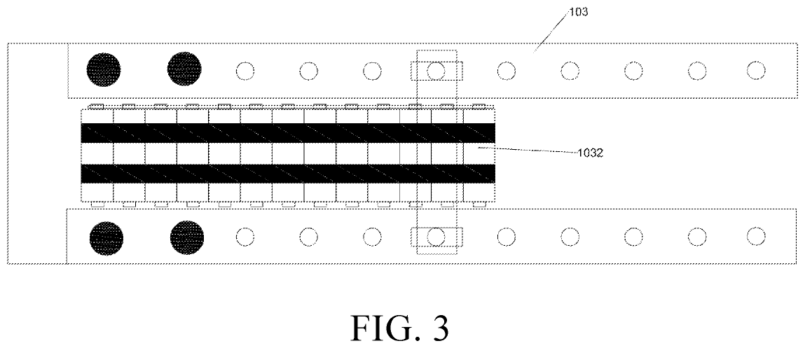

Wherein, the corresponding relationship between reference numerals and component names in FIGS. 1 to 5 is as follows:
101. driving mechanism; 1011. motor; 1012. small sheave; 1013. reducer; 1014. big sheave; 1015. driving belt; 102. earth axis; 103. stable feeding mechanism; 1031. stable table; 1032. roller sprocket device; 1033. lift regulating element 104. main flange; 105. secondary flange; 106. spacing regulating mechanism; 1061. mounting shaft; 1062. torsion spring; 1063. spacing regulator; 1064. spacing regulating member; 1065. positioning bolt; 1066. main feeding port; 1067. secondary feeding port; 107. plugging piece; 108. coupling.

### DESCRIPTION OF THE PREFERRED EMBODIMENTS

The present invention will be further described in detail in combination with accompanied drawings and embodiments for clear understanding of the purpose, features and advantages of the invention. It should be noted that the features in the embodiments and the embodiments of the present application may be combined with each other in a non-conflicting situation.

In the following description, numerous specific details are set forth in order to provide a thorough understanding of the present invention. However, the present invention may also be implemented in other ways different from those described here, so the protection scope of the present invention is not limited by the specific embodiments disclosed below.

The reinforcement cage rolling machine provided according to some embodiments of the present invention will be described below with reference to FIGS. 1 to 5.

Some embodiments of the present application provide a reinforcement cage rolling machine.

As shown in FIG. 1, the first embodiment of the present invention provides a reinforcement cage rolling machine, comprising:
a driving mechanism 101;
an earth axis 102, connected with a driving end of the driving mechanism 101;
a stable feeding mechanism 103, connecting the earth axis 102;
a main flange 104, arranged on the earth axis 102;
a secondary flange 105, arranged on the earth axis 102;
a spacing regulating mechanism 106, arranged on the main flange 104 and the secondary flange 105.

The reinforcement cage rolling machine proposed by the present invention comprises a driving mechanism 101, an earth axis 102, a stable feeding mechanism 103, a main flange 104, a secondary flange 105 and a spacing regulating mechanism 106. The driving mechanism 101 is used to provide a driving force for the earth axis 102, thereby driving the earth axis 102 to rotate. The earth axis 102 can be stably placed on the ground through provision of several bearing frames. The stable feeding mechanism 103 is used to ensure the automatic feeding process of reinforcement, so as to avoid the hidden dangers in feeding by workers. The spacing regulating mechanism 106 arranged on the main flange 104 and the secondary flange 105 can regulate the spacing between the reinforcements, so as to ensure that the overall stability of the reinforcement cage meets the quality standard and avoid potential safety hazards. In addition, the reinforcement cage rolling machine proposed by the invention automatically realizes the construction process of feeding and processing the reinforcement cage, saves time and labor, reduces the construction cost and improves the economic benefit.

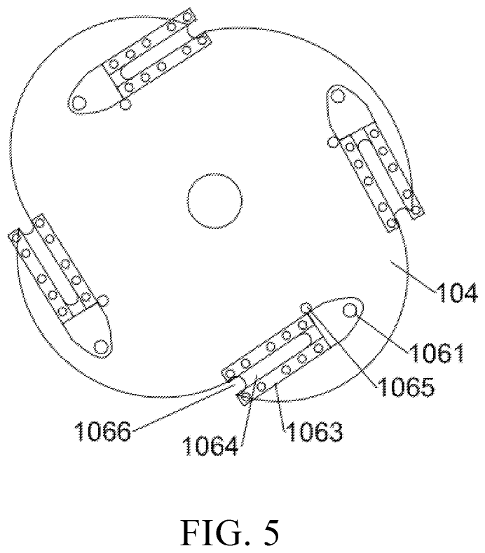

As shown in FIG. 5, the second embodiment of the present invention provides a reinforcement cage rolling machine, and based on the first embodiment, the spacing regulating mechanism 106 comprises:
a mounting shaft 1061, the main flange 104 and the secondary flange 105 forming a mounting hole, a torsion spring 1062 being arranged in the mounting hole, and the mounting shaft 1061 being sleeved with the torsion spring 1062;
a spacing regulator 1063, arranged on the mounting shaft 1061;
a spacing regulating member 1064, arranged on the spacing regulator 1063;
a positioning bolt 1065, arranged on the main flange 104 and the secondary flange 105 and located in contact with the side wall surface of the spacing regulator 1063.

In this embodiment, the spacing regulating mechanism 106 comprises a mounting shaft 1061, a torsion spring 1062, a spacing regulator 1063, a spacing regulating member 1064 and a positioning bolt 1065. The torsion spring 1062 can ensure the reset of the mounting shaft 1061, thereby driving the spacing regulator 1063 and the spacing regulating member 1064 to reset. The specific spacing regulating process is to change the spacing between reinforcements by rotating the spacing regulator 1063 by a certain angle. In addition, the spacing regulator 1063 is of a slotted structure, and the spacing regulating member 1064 is arranged in the slot and can be integrally formed with the spacing regulator 1063. One end of the spacing regulator 1063 is provided with a mounting hole for rotationally connecting with the mounting shaft 1061. At least one end of the spacing regulating member 1064 is of a semicircular notch to provide a clamping space for the reinforcement. The positioning bolt 1065 is in contact with the side wall surface of the spacing regulator 1063 to limit the freedom of the spacing regulator 1063.

As shown in FIG. 5, the third embodiment of the present invention provides a reinforcement cage rolling machine, and based on any of the above embodiments, further comprises:
a main feeding port 1066), formed at one end of the spacing regulating member 1064 of the main flange 104.

This embodiment further comprises a main feeding port 1066. The main feeding port 1066 is used to clamp reinforcements and realize the position change of the main feeding port 1066 through the spacing regulator 1063 and the spacing regulating member 1064, thereby changing the spacing between the reinforcement cages.

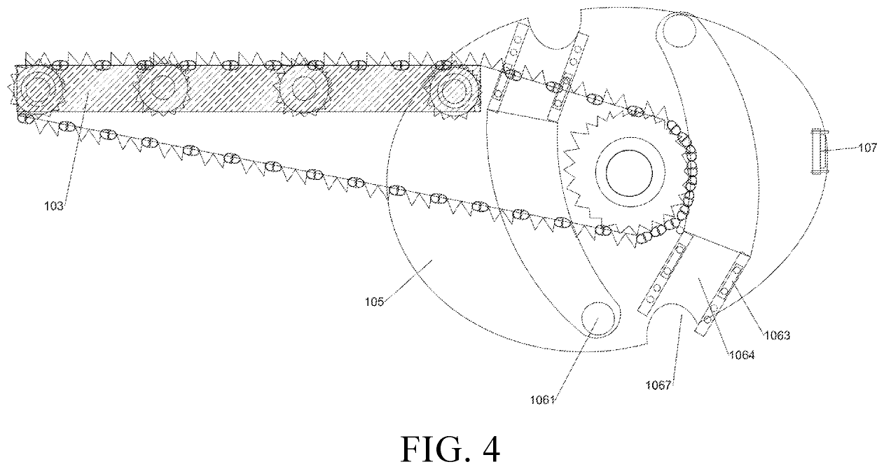

As shown in FIG. 4, the fourth embodiment of the present invention provides a reinforcement cage rolling machine, and based on any of the above embodiments, further comprises:
a secondary feeding port 1067, formed at one end of the spacing regulating member 1064 of the secondary flange 105.

This embodiment further comprises a secondary feeding port 1067. The secondary feeding port 1067 is formed in the same manner as that of the main feeding port 1066, and both of them are formed by the semicircular north of the spacing regulating member 1064.

As shown in FIGS. 4 and 5, the fifth embodiment of the present invention provides a reinforcement cage rolling machine, and based on any of the above embodiments, the quantity of the main feeding ports 1066 is four; and/or the quantity of the secondary feeding ports 1067 is two.

In this embodiment, there are four main feeding ports 1066, and correspondingly, there are two secondary feeding ports 1067. Of course, the quantity of both is determined according to the actual working conditions.

As shown in FIG. 4, the sixth embodiment of the present invention provides a reinforcement cage rolling machine, and based on any of the above embodiments, further comprises: a plugging piece 107, arranged on the secondary flange 105 and connected with part of the main feeding port 1066.

This embodiment further comprises a plugging piece 107. The plugging piece 107 is used to plug part of the main feeding port 1066, in order to prevent the reinforcement from passing through the main feeding port 1066.

As shown in FIG. 1, the seventh embodiment of the present invention provides a reinforcement cage rolling machine, and based on any of the above embodiments, the driving mechanism 101 comprises:
a motor 1011;
a small sheave 1012, arranged at the driving end of the motor 1011;
a reducer 1013, arranged at one side of the motor 1011;
a big sheave 1014, arranged on the reducer 1013, and the small sheave 1012 being connected with the big sheave 1014 through a driving belt 1015.

In this embodiment, the driving mechanism 101 comprises a motor 1011, a small sheave 1012, a reducer 1013 and a big sheave 1014. The motor 1011 drives the small sheave 1012 to rotate, thereby driving the big sheave 1014 to rotate through a driving belt 1015, and further driving the reducer 1013.

As shown in FIG. 1, the eighth embodiment of the present invention provides a reinforcement cage rolling machine, and based on any of the above embodiments, the earth axis 102 is connected with the driving end of the reducer 1013 through the coupling 108.

In this embodiment, the earth axis 102 is connected with the driving end of the reducer 1013 through the coupling 108. When the motor 1011 drives the reducer 1013 to rotate through a series of linkage, the reducer 1013 drives the earth axis 102 to rotate through the coupling 108.

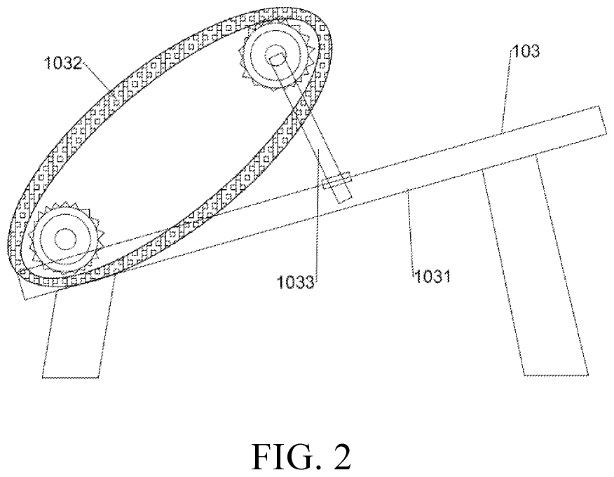

As shown in FIGS. 2, 3 and 4, the ninth embodiment of the present invention provides a reinforcement cage rolling machine, and based on any of the above embodiments, the stable feeding mechanism 103 comprises:
a stable table 1031, the table top of the stable table 1031 being an inclined structure;
a roller sprocket device 1032, rotationally connected with the stable table 1031 at one end close to the earth axis 102, and a lift regulating element 1033 being arranged at one end away from the earth axis 102;
wherein, a sprocket is arranged on the earth axis 102, and a roller chain of the roller sprocket device 1032 is sleeved with the sprocket.

In this embodiment, the stable feeding mechanism 103 comprises a stable table 1031, a roller sprocket device 1032 and a lift regulating element 1033. A mounting groove is provided in the middle of the stable table 1031. The sprocket near the earth axis 102 in the roller sprocket device 1032 is rotationally connected with the mounting groove, and the other end of the roller sprocket device 1032 is connected with the lift regulating element 1033. In addition, the earth axis 102 is also provided with a sprocket, and the roller chain of the roller sprocket device 1032 is connected to this sprocket to form a complete feeding mechanism. The height of one end of the roller sprocket device 1032 can be regulated by the lift regulating element 1033.

As shown in FIGS. 2, 3 and 4, the tenth embodiment of the present invention provides a reinforcement cage rolling machine, and based on any of the above embodiments, the roller sprocket device 1032 is provided with several equidistant placement stations.

In this embodiment, the roller sprocket device 1032 is provided with several equidistant placement stations which are used to hold reinforcements, change the reinforcement placement spacing and realize the change of spacing between reinforcements.

In the Description, the illustrative expressions of the above terms do not necessarily refer to the same embodiment or example. Moreover, the specific features, structures, materials or characteristics described may be appropriately combined in any one or more embodiments or examples. Any modification, equivalent replacement and improvement made within the spirit and rule of the present invention shall be incorporated in the protection scope of the present invention.

1. A reinforcement cage rolling machine, comprising:
a driving mechanism (101);
an earth axis (102), connected with a driving end of the driving mechanism (101);
a stable feeding mechanism (103), connecting the earth axis (102);
a main flange (104), arranged on the earth axis (102);
a secondary flange (105), arranged on the earth axis (102);
a spacing regulating mechanism (106), arranged on the main flange (104) and the secondary flange (105).

2. The reinforcement cage rolling machine according to claim 1, wherein the spacing regulating mechanism (106) comprises:
a mounting shaft (1061), the main flange (104) and the secondary flange (105) forming a mounting hole, a torsion spring (1062) being arranged in the mounting hole, and the mounting shaft (1061) being sleeved with the torsion spring (1062);
a spacing regulator (1063), arranged on the mounting shaft (1061);
a spacing regulating member (1064), arranged on the spacing regulator (1063);
a positioning bolt (1065), arranged on the main flange (104) and the secondary flange (105) and located in contact with the side wall surface of the spacing regulator (1063).

3. The reinforcement cage rolling machine according to claim 2, further comprising:
a main feeding port (1066), formed at one end of the spacing regulating member (1064) of the main flange (104).

4. The reinforcement cage rolling machine according to claim 3, further comprising:
a secondary feeding port (1067), formed at one end of the spacing regulating member (1064) of the secondary flange (105).

5. The reinforcement cage rolling machine according to claim 4, wherein
the quantity of the main feeding ports (1066) is four; and/or
the quantity of the secondary feeding ports (1067) is two.

6. The reinforcement cage rolling machine according to claim 1, further comprising:
a plugging piece (107), arranged on the secondary flange (105) and connected with part of the main feeding port (1066).

7. The reinforcement cage rolling machine according to claim 1, wherein the driving mechanism (101) comprises:
a motor (1011);
a small sheave (1012), arranged at the driving end of the motor (1011);
a reducer (1013), arranged at one side of the motor (1011);
a big sheave (1014), arranged on the reducer (1013), and the small sheave (1012) being connected with the big sheave (1014) through a driving belt (1015).

8. The reinforcement cage rolling machine according to claim 7, wherein the earth axis (102) is connected with the driving end of the reducer (1013) through a coupling (108).

9. The reinforcement cage rolling machine according to claim 1, wherein the stable feeding mechanism (103) comprises:
a stable table (1031), the table top of the stable table (1031) being an inclined structure;
a roller sprocket device (1032), rotationally connected with the stable table (1031) at one end close to the earth axis (102), and a lift regulating element (1033) being arranged at one end away from the earth axis (102);
wherein, a sprocket is arranged on the earth axis (102), and a roller chain of the roller sprocket device (1032) is sleeved with the sprocket.

10. The reinforcement cage rolling machine according to claim 9, wherein
the roller sprocket device (1032) is provided with several equidistant placement stations.
